(19) United States
(12) Patent Application Publication
(10) Pub. No.: US 2013/0072152 A1
(43) Pub. Date: Mar. 21, 2013

(54) MOBILE COMMUNICATION TERMINAL AND A DOWNLOAD ASSISTING METHOD

(71) Applicant: Ichiro OTA, Osaka (JP)

(72) Inventor: Ichiro OTA, Osaka (JP)

(73) Assignee: KYOCERA CORPORATION, Kyoto-shi (JP)

(21) Appl. No.: 13/620,234

(22) Filed: Sep. 14, 2012

(30) Foreign Application Priority Data
Sep. 20, 2011 (JP) 2011-204276

(51) Int. Cl. H04W 4/24

(52) U.S. Cl. 455/406

(57) ABSTRACT

A mobile phone (10) includes a RAM (34), etc., which is capable of downloading contents through a data communication with a network (100). The RAM (34) is stored with a charging condition table (340) in which a per-packet charge is recorded. If a communication charge key (RK) is operated in a state that the content is downloadable, it becomes possible to enter a file size of an image or video content. Then, when the file size is entered, a confirmation screen on which the communication charge necessary for downloading the content and a character string for confirming whether or not the download is to be performed are written is displayed on a display (30).

### CROSS REFERENCE OF RELATED APPLICATION

The disclosure of Japanese Patent Application No. 2011-204276 is incorporated herein by reference.

### BACKGROUND OF THE INTENTION

1. Field of the Invention

This present invention relates to a mobile communication terminal and a download assisting method, and more specifically, relates to a mobile-communication terminal and a download assisting method, capable of downloading contents.

2. Description of the Related Art

One example of a mobile communication terminal capable of downloading contents is disclosed in Japanese Patent Application Laying-Open No. 2003-141419 [G06F 17/60, H04L 12/56] laid-open on May 16, 2003. A communication navigating apparatus of this related art is capable of downloading from an information server information such as a map up to a destination, etc. In a case that the download is performed, the number of packets is calculated based on data that is downloaded, and a communication charge is billed based on the number of packets. Furthermore, in Japanese Patent Application Laying-Open No. 2005-341002 [H04M 11/00, H04M 1/725, H04Q 7/38]laid-open on Dec. 8, 2005, there is disclosed a mobile phone terminal having a function capable of making a trial calculation of the charge.

However, the communication navigating apparatus of the related art does not notify in advance to a user of a communication charge necessary for downloading the map up to the destination. Therefore, the user cannot grasp the communication charge necessary to arrive at the destination. Furthermore, in the mobile phone terminal of the other related art, it is possible to calculate the communication charge only after the processing of telephone conversation.

### SUMMARY OF THE INVENTION

Therefore, it is a primary object to provide a novel mobile communication terminal and a download assisting method.

It is another object to provide a mobile communication terminal and a download assisting method, capable of increasing conveniences or facilities in downloading the content

The present invention employs following features m order to solve the above-described problems. It should be noted that reference numerals and the supplements inside the parentheses show one example of a corresponding relationship with the embodiments described later for easy understanding of the present invention, and do not limit the present invention.

A first aspect according to the present invention is a mobile communication terminal capable of downloading contents through a data communication with a network, comprising: a storing portion which stores a unit price of a communication charge with respect to a data amount of the data communication; an acquiring portion which acquires a data size of the content to be downloaded; a calculating portion which calculates the communication charge necessary for downloading the content based on the unit price and the data size that is acquired by the acquiring portion; a notifying portion which notifies the communication charge calculated by the calculating portion; a confirming portion which confirms whether or not a download processing of the content is to be performed after the communication charge is notified by the notifying portion; and a performing portion which performs the download processing of the content at a time that it is confirmed by the confirming portion that the download processing of the content is to be performed.

A second aspect according to the present invention is a download assisting method of a mobile communication terminal which is capable of downloading contents through a data communication with a network and includes a storing portion which stores a unit price of a communication charge with reaped to a date amount, comprising steps of: acquiring a data size of the content to be downloaded; calculating the communication charge necessary for downloading the content based on the acquired data size and a unit price; notifying the communication charge calculated; confirming whether or not the download processing of the content is to be performed after the communication charge is notified; and performing the download processing of the content when it is confirmed that the download processing of the content is to be performed.

The above described objects and other objects, features, aspects and advantages of the embodiments will become more apparent from the following detailed description of the embodiments when taken in conjunction with the accompanying drawings.

### BRIEF DESCRIPTION OF THE DRAWINGS

FIG. 1 is an illustrative view showing electrical structure of a mobile phone that is an embodiment according to the present invention.

FIG. 2 as an illustrative view showing one example of a form of a charging condition table stored in an RAM shown in FIG. 1.

FIG. 3 is an illustrative view showing one example of a download site displayed on a display shown in FIG. 1.

FIG. 4 is an illustrative view showing one example of an input screen and confirmation screen both displayed on the display shown in FIG. 1.

FIG. 5 is an illustrative view showing one example of a cumulative communication charge displayed on the display shown in FIG. 1.

FIG. 6 is an illustrative view showing one example of a memory map of the RAM shown in FIG. 1.

FIG. 7 is a flowchart showing one example of a download assisting process of a processor shown in FIG. 1.

FIG. 8 is a flowchart showing one example of a communication charge calculating process of the processor shown in FIG. 1.

### DETAILED DESCRIPTION OF NON-LIMITING EXAMPLE EMBODIMENTS

With referring to FIG. 1, a mobile phone 10 is a kind of a mobile communication terminal, and includes a processor 24 called as a computer or a CPU. The processor 24 is connected with a wireless communication circuit 14, an A/D converter 16, a D/A converter 20, a key input device 26, a display driver 28, a flash, memory 32, a RAM 34 etc. Furthermore, an antenna 12 is connected to the wireless communication circuit 14. The A/D converter 16 is connected with a microphone 18 and the D/A converter 20 is connected with a speaker 22. A display 30 is connected to the display driver 28.

The processor 24 is in charge of a whole control of the mobile phone 10. The RAM 34 functions as a storing portion, and is used as a working area (including an image drawing area) and a buffer area for the processor 24. Data of the content such as characters, images or videos, sounds, voices, etc. of the mobile phone 10 is recorded in the flash memory 32.

The A/D converter 16 converts an analog sound signal of the sound or voice input through the microphone 18 into a digital sound signal. The D/A converter 20 converts (decodes) a digital sound signal into an analog sound signal to apply to the speaker 22 via an amplifier not shown. Therefore, a sound or voice corresponding to the analog sound signal is output from the speaker 22.

In addition, the processor 24 adjusts a sound volume of the sound output front the speaker 22 by controlling an amplification factor of the amplifier (not shown) connected to the D/A converter 20.

The key input device 26 functions as an operating portion, and includes a call key, an end key, a cursor key, first to third function keys, etc., and further a dial key including “0”-“9” keys, “*” key and “#” key. Information (key data) of the key operated by the user is input to the processor 24.

Here, the first to third function keys correspond to a left key LK, a center key CK and a right keg RK displayed on the display 30. Then, the user operates the key displayed on the display 30 by utilizing the first function key, the second function key and the third function key. Functions assigned to the left key LK, the center key CK and the right key RK are different in accordance with a screen being displayed. It is to be noted that in this specification and attached drawings, a case that the functions assigned to these keys are different from those of another case, these keys are identified by changing numerals of the symbol.

The display driver 28 controls the displaying of the display 30 connected to this display driver 28 coder instructions by the processor 24. In addition, the display driver 28 includes a video memory (not shown) which temporarily stores the image or video data to be displayed.

The display 30 is provided with a backlight which includes a light source of an LED. The backlight is provided to the display panel included in the display 30 on the basis of an edge light system. In addition, as the light source of the backlight, the LED is adopted in this embodiment shown, but a cathode ray tube or the like may be adopted in other embodiments.

The wireless communication circuit 14 is a circuit for performing a wireless communication with a CDMA system. For example, if the user designates a telephone call using a key input device 26, the wireless communication circuit 14 performs a telephone call processing under instructions from the processor 24 and outputs a telephone call signal via the antenna 12. The telephone call signal is transmitted to a telephone at the other end of the line through a base station and a communication network (not shown). Then, an incoming processing is performed in the telephone at the other end of the line, a communication-capable state is established and the processor 24 starts the telephonic communication processing.

Describing specifically, a normal telephonic communication processing, a modulated sound signal sent from a telephone at the other end of the line is received by the antenna 12. The modulated sound signal received is subjected to a demodulation processing and a decode processing by the wireless communication circuit 14. A received sound signal obtained through such processing is converted into an analog sound signal by the D/A converter 20 to be output from the speaker 22. On the other hand, a sending sound signal taken-in through the microphone 18 is converted into a digital sound signal by the A/D converter 18 to be applied to the processor 24. The sending sound signal which is converted into the digital sound signal is subjected to an encode processing and a modulation processing by the wireless communication circuit 14 under instructions by the processor 24 to be output via the antenna 12. Therefore, the modulated sound signal is transmitted to the telephone at the other end of the line via the base station and the communication network.

When the telephone call signal from a telephone at the other end of the line is received by the antenna 12, the wireless communication circuit 14 notifies the processor 24 of the incoming call. In response thereto, the processor 24 displays on the display 30 sender information (telephone number and so on) described in the incoming call notification by controlling the display driver 28. In addition, at the approximately same time, the processor 24 outputs from the speaker a ringtone (may be also called as a ringtone melody, a ringtone voice).

Then, If the user performs a responding operation by using the call key, the wireless communication circuit 14 performs the incoming call processing under instructions by the processor 24. Furthermore, the communication-capable state is established, the processor 24 performs the above-described normal telephone communication processing.

If the telephone communication ending operation is performed by the end key after a state is changed to the communication-capable state, the processor 24 transmits the telephone communication ending signal to the telephone at the other end of the line by controlling the wireless communication circuit 14. Then, after the transmission of the telephone communication ending signal, the processor 24 terminates the telephone communication processing. Furthermore, in a case that the telephone ending signal from the telephone at the other end of the line is previously received, the processor 24 also terminates the telephone communication processing. In addition, in a case that the telephone communication ending signal is received from the mobile communication network not from the telephone at the other end of the line, the processor 24 also terminates the telephone communication processing.

In addition, the mobile phone 10 can establish a data communication with a server 102 via a network 100. The server 102 is included with a data server, a mail server and so on. Therefore, the mobile phone 10 can implement a browsing function for reading the data and downloading the content, a mailing function for performing transmission/reception of mails by performing data communication with the server 102.

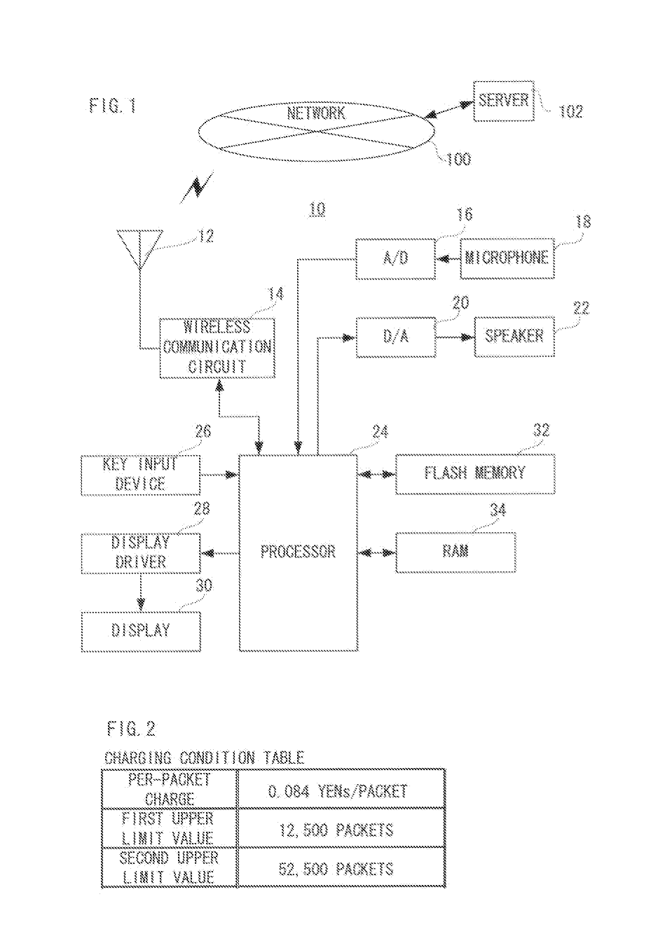

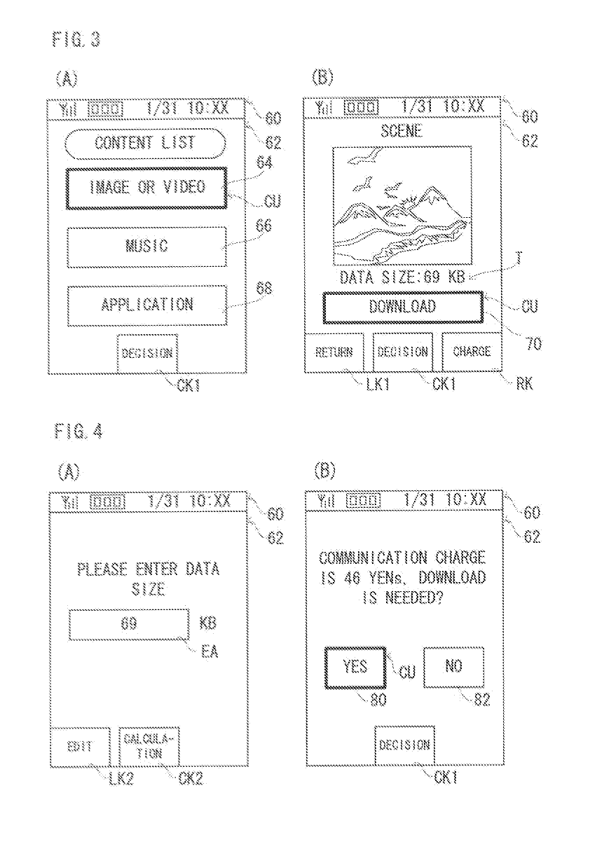

In the data communication by the browsing function or the mailing function, a communication charge occurs with respect to an amount of data transmitted and received. Then, a unit price of a communication charge with respect to the data amount in the data communication with the server, and so on are stored in the charging condition table shown in FIG. 2.

With referring to FIG. 2, in the charging condition table, as a per-packet charge, “0.084 Yens/packet” is recorded, and as a first upper limit value, “12,500 packets” is recorded, and as a second upper limit value, “52,500 packets” is recorded. Here, the packet is a data transfer unit in the data communication utilizing the 3G channel, etc. The per-packet charge indicates an amount of money to be charged per a packet. Therefore, in a case that the per-packet charge is “0.084 Yens/packet”, if the data of one (1) packet is transmitted/received, the communication charge of 0.084 Yens is billed.

The first upper limit value and the second upper limit value are utilized for determining whether or not the communication charge occurs in a case of a two-step flat-charge system in a charging plan (charging system). Specifically, by paying a first flat-charge, in a case that a cumulative total number of the packets (cumulative total data amount) is equal to or less than the first upper value during a charge calculation period, the data communication charge becomes a predetermined amount of money (0 Yen, for example). Similarly, in a case that the cumulative total number of the packets is larger than the second upper value, by paying a second flat-charge, the data communication charge will become a predetermined amount of money.

If the cumulative total number of the packets is 5,000 packets, for example, since the cumulative total number of packets is less than 12,500 packets that is the first upper value, the communication charge of the data communication becomes 0 Yen (the predetermined amount of money). In a case that the cumulative total number of packets is 60,000 packets, the cumulative total number of packets is more than the second upper value, the communication charge of the data communication becomes 0 Yen (the predetermined amount of money). However, the cumulative total number of the packets is less than the first upper limit value or more than the second upper limit value, as the communication charge of the charge calculation period of one month, “1,000 Yens” being the first flat-charge or “4,200 Yens” being the second flat-charge, for example is billed to the user.

In addition, it is to be noted that the above-described specific numeral values for the per-packet charge, the first upper limit value (the first threshold value), the second upper limit value, the predetermined amount of money, the first flat-charge, the second flat-charge, the charge calculation period and so on are only examples, and may be different numeral values in other embodiments.

Furthermore, in other embodiments, the flat-charge system in the data communication charge may be a single step or may three steps or more. For example, the second flat-charge is not set especially, if the cumulative total number of the packets is larger than the second upper limit value, as the communication charge, “4360 Yens” may be calculated by adding the communication charge up to the second upper limit value ({52,500 packets−12,500 packets}×0.084 Yens=3,360 Yens) to “1,000 Yens” that is the first flat-charge.

The charging condition table may be manually set by the user, or automatically set under the contract of the mobile phone 10. Furthermore, the charging condition table may be set after the information is obtained through the data communication at a timing that the charging plan is changed. Furthermore, the charging condition table may be set after information is obtained through the data communication at a time that a communication charge key RK described later is operated.

Furthermore, in this embodiment, one (1) packet is 128 bytes, and therefore, if and when 128 en (1 byte) characters or 64 em (2 bytes) characters are transmitted or received, the communication charge of one packet occurs.

FIGS. 3(A) and 3(B) are illustrative views showing one example of a download site for downloading the content. With referring to FIG. 3(A), a displaying range of the display 30 (FIG. 1) includes a state displaying area 60 and a function displaying area 62. An icon (picto) showing a radio wave receiving state by the antenna 12, the icon showing a residual battery capacity of a secondary battery and the date and time are displayed in the state displaying area 60.

In the function displaying area 62, a content list screen of the download site displayed by the browsing function is displayed. In the content list screen, an image or video link key 64, a music link key 66 and an application link key 68 for respectively downloading an image or video content, a music content and an application content are included. Furthermore, a cursor CU and a decision key CK1 are displayed in the function displaying area 62.

The cursor CU is changed in its displayed position according to an operation of the cursor key. The decision key CK1 is the center key CK. Then, if the decision key CK1 is operated, in a state that either of the link key s selected by the cursor CU, according to the selected link key, a screen showing a detail of the content is displayed. For example, if the decision key CK1 is operated in a state that the image or video link key 64 is selected by the cursor CU, a detailed screen shown in FIG. 3(B) is displayed.

With referring to FIG. 3(B), in the detailed screen, a character string representing a title of the image or video content and a sample image of the image or video content are included, and further a character string T representing a data size of the image or video content, and a download key 70 for performing a download processing of the image or video content are included. Then, in the function displaying area 62, the cursor CU, a return key LK1, the decision key CK1 and the communication charge key RK are displayed.

For example, the user can determine whether or not the image or video content is to be downloaded on the basis of the sample image and the data size of the image or video content indicated by the character string T (69 KB (kilobytes)). The user can return to the content list screen shown in FIG. 3(A) without downloading the image or video content by operating the return key LK1. On the other hand, in a case that the download of the image or video content is to be performed, the user can download the image or video content by operating the decision key CK1 in a state that the download key 70 is selected by the cursor CU.

In addition, “K (kilo)” in the unit of the data size is a binary prefix, not an SI prefix. That is, “K (kilo)” means “2¹⁰=1024 times”, and therefore, “1 KB” becomes “1024 bytes”.

Here, in order to know the communication charge necessary for downloading the content, the user must calculate by himself/herself based on the data size indicated by the character string T. Furthermore, if the user forgets the per-packet charge, and/or does not grasp the cumulative total number of the packets, it is impossible to calculate the communication charge. In such a case, the user must determine whether or not the image or video content is to be downloaded without grasping the communication charge.

Therefore, in this embodiment, by notifying the user of the communication charge necessary for downloading the content prior to the download of the content, it is easy for the user to determine whether or not the download is to be performed.

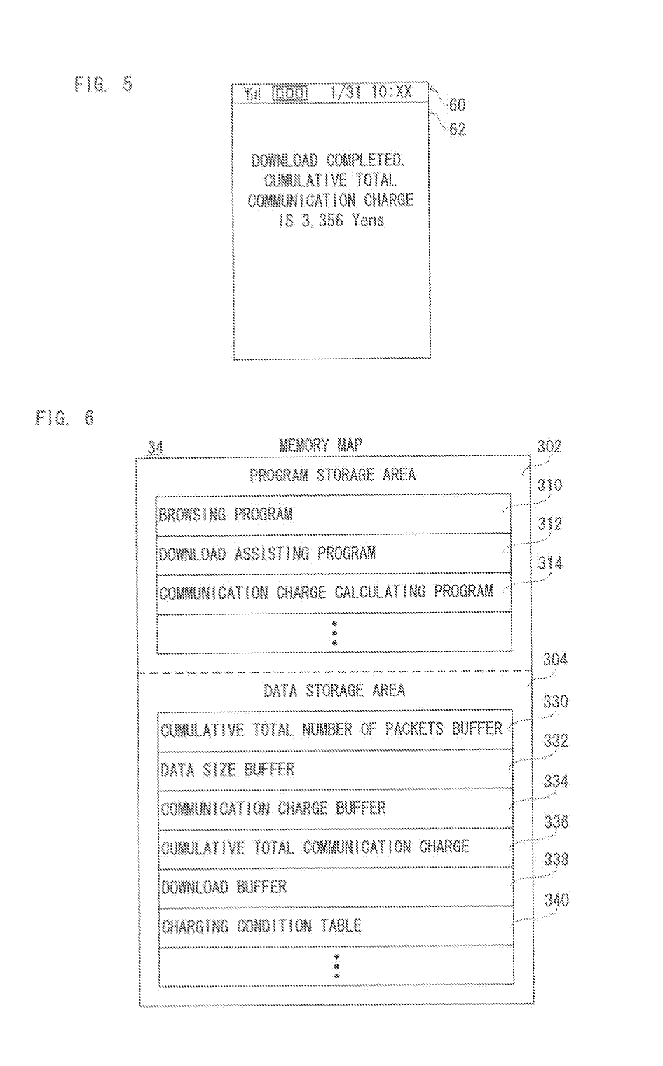

With referring to FIG. 4(A), when the communication charge key RK in FIG. 3 is operated, an input screen is displayed in the function displaying area 62. In the input screen, an enter area EA for entering the data size of the content to be downloaded with the unit of “KB (kilobytes)” is included. Furthermore, in the function displaying area 62, an edit key LK2 for editing the character string in the enter are EA and the calculation key CK2 are displayed. For example, the edit key LK2 is operated, and the character string of “69” is input, and thereafter, such an input is decided, the enter area EA is rendered to a state that the data size is entered as “69 KB”.

Furthermore, if the communication charge key RK is operated, the cumulative total number of the packets is acquired through the data communication, and it is rendered to a state that the result is stored in the buffer in the RAM 34.

Then, at a time that the calculation key CK2 is operated, if the cumulative total number of the packets is more than the first upper limit value or equal to or less than the second upper limit value, the input data size and the per-packet charge are substituted into the equation 1 such that the communication charge can be calculated.

(data size×1.024)/128×per-packet charge=communication charge [Equation 1]

For example, if the cumulative total number of the packets is “40000 packets”, the per-packet charge is “0.084 Yens/packet” as shown in FIG. 2, and the data size is “69 KB”; the communication charge becomes “46 Yens”. However, if the cumulative total number of the packets is equal to or less than the first upper limit value or more than the second upper limit value, the communication charge is set as “0 Yen (predetermined amount of money)”.

With referring to FIG. 4(B), a communication screen including the calculated communication charge (46 Yens) is displayed in the function displaying area 62. In the confirmation screen, a character string for confirming the download of the content, a consent key 80 and a refusing key 82 are included. Furthermore, in the function displaying area 62, in addition to the confirmation screen, the cursor CU and the decision key CK1 for selecting the consent key 80 or the refusing key 82 are displayed.

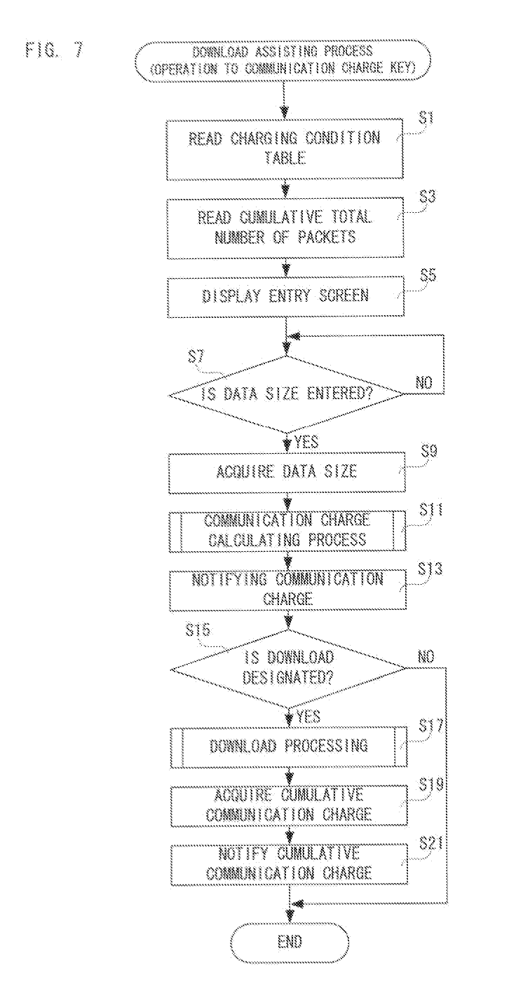

If the decision key CK1 is operated in a state that the consent key 80 is selected by the cursor CU, the download processing of the image or video content, for example, is performed. Then, if the download processing is ended, a cumulative total communication charge during the charge calculation period is acquired through the data communication. Therefore, as shown in FIG. 5, a character string notifying that the download is completed, and a character string showing the cumulative total communication charge (3,356 Yens) are displayed in the function displaying area 62. This displaying is erased after a predetermined time (three (3) seconds, for example) lapses, and the displaying returns to the content list screen of FIG. 3(A). In addition, if the communication charge is the predetermined amount of money, as the cumulative total communication charge in FIG. 5, the first flat-charge or the second flat-charge is notified. Furthermore, the cumulative total communication charge (3,365 Yens) may be notified to the user with the communication charge (46 Yens) in FIG. 4(B).

On the other hand, in a case that the refusing key 82 is operated, the displaying returns to the detailed screen in FIG. 3(B) without performing the download processing of the content.

Thus, in this embodiment if is possible for the user to determine whether or not the download is to be performed by notifying in advance the communication charge necessary for the download of the content. Therefore, in performing the download of the content, the convenience or facility increases.

Furthermore, oven if the charging plan that the communication charge is varied according to the cumulative total number of the packets is adopted, it is possible to notify the user of an accurate communication charge.

FIG. 6 is a view showing a memory map of the RAM 34. The RAM 34 includes a program storage area 302 and a data storage area 304. In addition, the program and data are read-out wholly at once or partly and sequentially read out as necessary from the flash memory 32 to be stored in the RAM 34.

The program storage area 302 is stored with a program for operating the mobile phone 10. In the program for operating the mobile phone 10, a browsing program 310, a download assisting program 312 and a communication charge calculating program 314, for example are included.

The browsing program 310 is a program for performing a browsing function. The download assisting program 312 is a program for notifying in advance the user of the communication charge occurring at a time that the content is downloaded. The communication charge calculating program is a subroutine included in the download assisting program 312, and a program for calculating the communication charge.

In addition, although not shown, the program for operating the mobile phone 10 further includes a program for performing a music player function and so on.

In the data storage area 304, a cumulative total number of packets buffer 330, a data size buffer 333, a communication charge buffer 334, a cumulative total communication charge buffer 336, a download buffer 338 and so on are formed, and the data of the charging condition table 340 is stored.

In the cumulative total number of packets buffer 330, the cumulative total number of the packets acquired through the data communication or the like is temporarily stored. In the data size buffer 332, the data size (69 KB) entered by the user is temporarily stored. In the communication charge buffer 334, the communication charge calculated by the communication charge calculating program 314 is temporarily stored. In the cumulative total communication charge buffer 336, the cumulative total of the communication charge during the charge calculation period acquired through the data communication is temporarily stored. The download buffer 338 temporarily stores the downloaded content.

The data of the charging condition table 340 is data of a table corresponding to the charging condition table shown in FIG. 2, for example.

Although not shown, the data storage area 304 is stored with an image data displayed on the display 30 in a standby slate, the data of the character string, etc., and is further formed with counters and flags necessary for an operation of the mobile phone 10.

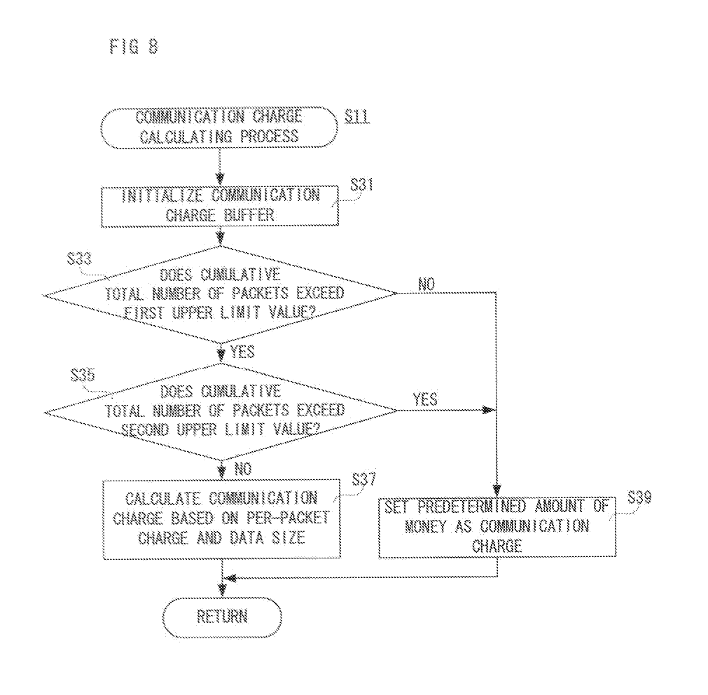

The processor 24 processes a plurality of tasks including the download assisting process shown in FIG. 7, the communication charge calculating process shown in FIG. 8 and so on in parallel with each other under controls by Linux (registered trademark)-base OS such as Android (registered trademark) and REX or other OSs.

FIG. 7 shows a flowchart of the download assisting process. For example, if the communication charge key RK shown in FIG. 3(B) is operated, the processor 24 reads, in a step S1, the data of the charging condition table. For example, from the charging condition table shown in FIG. 2, “0.084” is read as the per-packet charge, “12,500” is read as the first upper limit value, “52,500” is read as the second upper limit value. Succeedingly, in a step S3, the cumulative total number of the packets is read. If the step S3 is executed, first, the cumulative total number of the packets is obtained through the data communication, and the cumulative total number of the packets is stored once in the cumulative total number of the packets buffer 330. Thereafter, the cumulative total number of the packets is read from that buffer.

Succeedingly, the input screen is displayed In a step S5. That is, the input screen shown in FIG. 4(A) is displayed on the display 30. In a succeeding step S3, it is determined whether or not the data size is entered. For example, it is determined whether or not the calculation key CK2 is operated in a state that the numeral string is displayed in the entry area EA. If “NO” is determined in the step S7, that is, if the calculation key CK2, for example is not operated, the determination in the step S7 is repeated. On the other hand, if “YES” is determined in the step S7, that is, if the calculation key CK2 for example is operated, a data size is acquired in a step S9. The numeral string being displayed in the entry area EA is stored in the data size buffer 332. Therefore, in the step S9, the data size is acquired from the data size buffer 332. In addition, the processor 24 executing the processing in the step S9 functions as an acquiring portion.

Succeedingly, in a step S11, the communication charge calculating process is executed. In addition, since the communication charge calculating process will be described later with utilizing FIG. 8, a detailed description thereof is omitted here. In addition, the processor 24 executing the processing in the step S11 functions as a calculating portion.

In a step S13, the communication charge is notified. For example, the communication charge is read from the communication charge buffer 334, and the confirmation screen including the communication charge is displayed on the display 30. Succeedingly, in a step S15, it is determined whether or not the download is designated. For example, it is determined whether or not the decision key CK1 is operated in a state that the consent key 80 is selected by the cursor CU in the confirmation screen. In addition, the processor 24 executing the processing in the step S13 functions as a notifying portion, and the processor 24 executing the processing in the step S15 functions as a confirming portion.

When “NO” is determined in the step S15, if the decision key CK1 is operated in a state that the refusing key 82 is selected, the download assisting process is terminated. In contrast, when “YES” is determined in the step S15, if the decision key CK1 is operated in a state that the consent key 80 is selected, the download processing is performed in a step S17. For example, the image or video content corresponding to the sample image shown in FIG. 3(B) is downloaded. In addition, the processor 24 executing the processing in the step S17 functions as a performing portion.

Succeedingly, in a step S19, the cumulative total communication charge is acquired. For example, the cumulative total communication charge during the charge calculation period through the data communication is acquired. Then, the cumulative total communication charge thus acquired is recorded in the cumulative total communication charge buffer 336. Next, in a step S21, the cumulative total communication charge is notified. For example, as shown in FIG. 5, the character string indicating the cumulative total communication charge is displayed on the display 30. Then, when the processing in the step S21 is ended, the download assisting process is terminated.

FIG. 8 is a flowchart of the communication charge calculating process. If and when the step S11 is executed in the download assisting process in FIG. 7, the processor 24 initializes the communication charge buffer 334 in a step S31. Next, in a step S33, it is determined whether or not the cumulative total number of the packets exceeds the first upper limit value. For example, it is determined whether or not the cumulative total number of the packets acquired exceeds 12,500 packets (the first upper limit value) shown in FIG. 2. If “NO” is determined in the step S33, that is, if the cumulative total number of the packets does not exceed the first upper limit value, the process proceeds to a step S39. In addition, if “YES” is determined in the step S33, that is, if the cumulative total number of the packets exceeds the first upper limit value, in a step S35, it is determined that the cumulative total number of the packets exceeds the second upper limit value. For example, it is determined whether or not the cumulative total number of the packets acquired exceeds 52,500 packets (the second upper limit value) shown in FIG. 2. If “YES” is determined in the step S35, that is, if the cumulative total number of the packets exceeds the second upper limit value, the process proceeds to a step S39. On the other hand, If “NO” is determined in the step S35, that is, if the cumulative total number of the packets is equal to or less than the second upper limit value, in a step S37, the communication charge is calculated on the basis of the per-packet charge and the data size. That is, by substituting the per-packet charge and the data size into the above-described equation 1, the communication charge is calculated. Then, the calculated communication charge is recorded in the communication charge buffer 334. In addition, if the processing in the step S37 is ended, the process returns to the download assisting process. The processor 24 executing the processing in the step S37 functions as a calculating portion.

Furthermore, If the cumulative total number of the packets does not exceed the first upper limit value or if the cumulative total number of the packets exceeds the second upper limit value, in the step S39, the predetermined amount of money is set as the communication charge. For example, since no communication charge occurs, in the communication charge buffer 334, “0” is recorded. Then, if the processing in the step S39 is ended, the process returns to the download assisting process.

In addition, in other embodiments, if the cumulative total number of packets does not exceed the first upper limit value, or if the cumulative total number of packets exceeds the second upper limit value, by modifying the per-packet charge to “0 Yen”, the communication charge may be calculated as “predetermined amount of money, 0 Yen”.

In addition, in further other embodiments, the data size may be automatically acquired. For example, the numeral string before “KB” included in the detailed screen may be automatically acquired, or in a case that the format of the information of the data size is fixed in a page displaying the data size, the data size may be automatically acquired by utilizing the format. In addition, the data size thus automatically acquired is stored in the data size buffer 332. Then, in a case that the data size is automatically acquired, in the download assisting process in FIG. 7, the steps S5 and S7 can he omitted, and in the processing in the step S9, the data size is automatically acquired.

Furthermore, in still further other embodiments, the cumulative total number of the packets during the charge calculation period may be accumulated by the mobile phone 10. In such a case, since it becomes unnecessary to acquire the cumulative total number of the packets through the data communications, a processing time until the communication charge is notified becomes shorter.

In a case that the mobile phone 10 accumulates the cumulative total number of packets during the charge calculation period, at only a time that the cumulative total number of the packets exceeds the predetermined threshold value (second threshold value), the calculation of the communication charge and the notification of the communication charge may become executable. In such a case, if the cumulative total of the communication charge is a lower price, there are many possibilities that the calculation of the communication charge is not needed to the user. Therefore, in only a case that the cumulative total number of the packets exceeds the threshold value, the communication charge is calculated, thereby to omit unnecessary calculating process. In addition, the threshold value maybe set by the user, and the first upper limit value (12,500 packets) or the second upper limit value (52,500 packets) may be set.

In a case that the mobile phone 10 is a smartphone comprising a whole surface touch panel, the respective link keys, download key 70, etc. displayed on the display 30 become to be operated by a touch operation. Therefore, on the display 30, the cursor CU, the left key LK, the center key CK and the right key RK become not to be displayed.

Furthermore, the communication charge and the cumulative total communication charge may be displayed on the display 30 after the consumption tax is added thereto.

Furthermore, in the equation 1, if the unit of the data size is “B” the data size is not multiplied with “1024”; but if the unit of the data size is “MB”, the data size is multiplied with “2²⁰=1048576”.

In further other embodiments, the data size may be acquired after conversion to “B (byte)”. In this case, the communication charge will be calculated according to the equation 2.

data size/128×per-packet charge=communication charge [Equation 2]

Furthermore, in still further embodiments, the communication charge may be notified to the user by the voice message or the like.

Furthermore, a communication system of the mobile phone 10 in the embodiments is a CDMA system, but an LTE system, a W-CDMA system, a GSM system, a TDMA system, a FDMA system, a PHS system or the like may be adopted. Furthermore, as the display 30, an LCD monitor is utilized, but an organic EL panel or the like may be adopted. The appearance of the mobile phone 10 may be a straight-type, a slide-type, a one-axis or two-axis foldable type.

A plurality of programs utilized in the above-described embodiments may be stored in a HDD of the server for data distribution, and distributed to the mobile phone 10 via the network. The plurality of programs may be stored in a storage medium, such as an optical disk of CD, DVD, BD (Blu-ray Disc) or the like, a USB memory, a memory card, etc. and then, such the storage medium may be sold or distributed. In a case that the plurality of programs downloaded via the above-described server or storage medium are installed to a mobile phone having the structure equal to the structure of the embodiment it is possible to obtain advantages equal to advantages according to the embodiment.

Furthermore, the above-described embodiments may be adapted not only to the mobile phone 10 but also so-called a smartphone, an electronic book terminal, a tablet PC, a PDA and so on.

The specific numerical value mentioned in this specification are only examples, and changeable properly in accordance with the change of product specifications.

The embodiment is a mobile communication terminal capable of downloading contents through a data communication with a network, comprising a storing portion which stores a unit price of a communication charge with respect to a data amount of the data communication; an acquiring portion which acquires a data size of the content to be downloaded; a calculating portion which calculates the communication charge necessary for downloading the content based on the unit price and the data size that is acquired by the acquiring portion; a notifying portion which notifies the communication charge calculated by the calculating portion; a confirming portion which confirms whether or not a download processing of the content is to be performed after the communication charge is notified by the notifying portion; and a performing portion which performs the download, processing of the content at a time that it is confirmed by the confirming portion that the download processing of the content is to be performed.

In the embodiment, a mobile communication terminal (10: a reference numeral exemplifying corresponding portion in the embodiment, and so forth) cars download contents of an image or video, music, application, etc. through the data communication with the network (100). The storing portion (34) stores the unit price of the communication charge with respect to the data, amount of one packet, for example, that is, the per-packet charge. The acquiring portion (24, S9) acquires the data size of the content entered by the user, for example. The calculating portion (24, S11, S37) calculates the communication charge necessary for downloading the image or video content or the like based on the input data size and the unit price, for example. The notifying portion (24, S13) notifies the user of the calculated communication charge by displaying the same on the display 30, for example. The confirming portion (24, S15) determines after the communication charge is notified, whether or not the key for performing the download processing is operated. The performing portion (24, S17) performs the download processing for the content if the operation with respect to the key for performing the download processing is confirmed by the confirming portion.

According to the embodiment, by previously notifying the user of the communication charge necessary for the download of the content, it is possible to make the user determine whether or not the download is to be performed. Therefore, in performing the download of the content, the convenience or facility increases.

In another embodiment, the storing portion further stores a cumulative total amount of data downloaded during a charge calculation period, and the calculating portion calculates the communication charge based on the cumulative total amount of data and the data size acquired by the acquiring portion.

In this embodiment, for example, the charge calculation period is one month, and the cumulative total amount of data is a sum total of the data transmitted/received during that period. The storing portion further stores the cumulative total amount of data. Then, the calculating portion calculates the communication charge based on the cumulative total amount of data and the data size acquired.

In accordance with this embodiment, even if the charging plan that the communication charge is changed according to the cumulative total amount of data, e.g. the cumulative total number of the packets is adopted, it is possible to notify the user of an accurate communication charge.

In a further embodiment, the calculating portion sets the communication charge with a predetermined amount of money at a time the cumulative total amount of data is equal to or less than a first threshold value.

In the further embodiment, when the cumulative total amount of data is equal to or less than the first threshold value (the first upper limit value; 12,500 packets, for example), “0 Yen (predetermined amount of money)”, for example is set as the communication charge.

According to the further embodiment, it is possible to notify the user that the communication charge due to the download does not occur if the cumulative total amount of data is equal to or less than the first threshold value.

In a still farther embodiment, the calculating portion calculates the communication charge necessary for downloading the content based on the data size acquired by the acquiring portion and the unit price when the cumulative total amount of data stored in the storing portion is more than a second threshold value.

In the still further embodiment, the second threshold value is set by the user, for example. Then, if the cumulative total amount of data is larger than the second threshold value set by the user, the communication charge is calculated.

According to the still further embodiment, it is possible to make the user think that if the sum total of communication charge is low, the calculation of the communication charge is not needed for the user, in a case that the cumulative total amount of data exceeds the second threshold value only, the calculation of communication charge is performed such that an unnecessary calculation may not be performed.

The other embodiment is a download assisting method of a mobile communication terminal which is capable of downloading contents through a data communication with a network and includes a storing portion which stores a unit price of a communication charge with respect to a data amount, comprising steps of: acquiring a data size of the content to be downloaded; calculating the communication charge necessary for downloading the content based on the acquired data size and a unit price; notifying the communication charge calculated; confirming whether or not the download processing of the content is to be performed after the communication charge is notified; and performing the download processing of the content when it is confirmed that the download processing of the content is to be performed.

According to the other embodiment, by notifying the user of the communication charge necessary for the download of the content, it is possible to make the user determine whether or not the download is to be performed. Therefore, in performing the download of the content, the convenience or facility increases.

Although, the present invention has been described and illustcharged in detail, it is clearly understood that the same is by way of illustration and example only and is not to be taken by way of limitation, the spirit and scope of the present invention being limited only by the terms of the appended claims.

What is claimed is:

1. A mobile communication terminal capable of downloading contents through a data communication with a network, comprising:
a storing portion which stores a unit price of a communication charge with respect to a data amount of the data communication;
an acquiring portion which acquires a data size of the content to be downloaded:
a calculating portion which calculates the communication charge necessary for downloading the content based on the unit price and the data size that is acquired by the acquiring portion;
a notifying portion which notifies the communication charge calculated by the calculating portion;
a confirming portion which confirms whether or not a download processing of the content is to be performed after the communication charge is notified by the notifying portion; and
a performing portion which performs the download processing of the content at a time that it is confirmed by the confirming portion that the download processing of the content is to be performed.

2. A mobile communication terminal according to claim 1, wherein the storing portion further stores a cumulative total amount of data downloaded during a charge calculation period, and the calculating portion calculates the communication charge based on the cumulative total amount of data and the data size acquired by the acquiring portion.

3. A mobile communication terminal according to claim 2, wherein the calculating portion sets the communication charge with a predetermined amount of money at a time the cumulative total amount of data is equal to or less than a first threshold value.

4. A mobile communication terminal according to claim 2, wherein the calculating portion calculates the communication charge necessary for downloading the content based on the data size acquired by the acquiring portion and the unit price when the cumulative total amount or data stored in the storing portion is more than a second threshold value.

5. A download assisting method of a mobile communication terminal which is capable of downloading contents through a data communication with a network and includes a storing portion which stores a unit price of a communication charge with respect to a data amount, comprising steps of:
acquiring a data size of the content to be downloaded;
calculating the communication charge necessary for downloading the content based on the acquired data size and a unit price;
notifying the communication charge calculated;
confirming whether or not the download processing of the content is to be performed after the communication charge is notified; and
performing the download processing of the content when it is confirmed that the download processing of the content is to be performed.
